(19) United States
(12) Patent Application Publication
(10) Pub. No.: US 2003/0075367 A1
(43) Pub. Date: Apr. 24, 2003

(54) Electrically powered scooter

(76) Inventors: Jeffrey Palic, Dearborn, MI (US); Scott P. Slimak, Royal Oak, MI (US)

Correspondence Address: FORD GLOBAL TECHNOLOGIES, INC, SUITE 600 - PARKLANE TOWERS EAST, ONE PARKLANE BLVD., DEARBORN, MI, 48126, US

(21) Appl. No.: 09/682,795

(22) Filed: Oct. 19, 2001

(51) Int. Cl. B60K 1/00

(52) U.S. Cl. 180/65.1

(57) ABSTRACT

A scooter 10 having a removable battery assembly 24. Particularly, battery assembly 24 may have a protruding portion 26 upon which electrically conductive terminals 28, 30 are deployed. The portion 26 is selectively and removably inserted into recess 38 of terminal member 34, thereby allowing electrical energy to be communicated, from the battery 24 to a torque generator 22.

### BACKGROUND OF INVENTION

(1) Field of the Invention

The present invention generally relates to an electrically powered scooter and more particularly, to an electrically powered scooter having a selectively removably battery assembly.

(2) Background of the Invention

An electrically powered scooter is typically adapted to transport at least one individual by the use of electrical energy which is stored within a battery assembly disposed upon and/or within the scooter and which is communicated to a drive assembly which rotates at least one of the wheels of the scooter. While such a scooter has become somewhat popular, it has several drawbacks.

By way of example and without limitation, the electrical battery is fixedly mounted within the scooter and is not generally removable without damaging the scooter, thereby increasing the cost and complexity of replacing a damaged battery. Further, the battery is required to be periodically re-charged or re-energized and such re-energization undesirably requires that the scooter be inoperable while the battery is being recharged (e.g., the battery cannot operate the scooter as it is being re-energized). Further, the scooter must be deployed in close proximity to an electrical outlet in order to allow power to be communicated to the scooter. Often, the scooter is bulky, relatively large, and heavy and is not easily placed within the close confines of a garage or other location, necessary for the battery to receive electrical charge. Moreover, the battery assembly is typically and relatively expensive and is therefore highly susceptible to theft from an unattended or parked scooter (e.g., the battery is forcibly removed from the scooter assembly).

The present invention overcomes these drawbacks in a new and novel manner.

### SUMMARY OF INVENTION

It is a first non-limiting advantage of the present invention to provide an electrically powered scooter which overcomes some or all of the previously delineated drawbacks associated with prior scooters.

It is a second non-limiting advantage of the present invention to provide an electrically powered scooter which overcomes some or all of the previously delineated drawbacks associated with prior scooters and which, by way of example and without limitation, includes an easily removable battery assembly.

According to a first aspect of the present invention, a scooter is provided and includes a battery which is removable from the scooter without damaging the scooter.

According to a second aspect of the present invention, a scooter is provided. Particularly, the scooter includes a torque generator; at least one wheel which is coupled to the torque generator; a battery having a pair of oppositely charged terminals which is removably coupled to the torque generator; and at least one member which is removably attached to the battery and to the scooter and which allows the battery to be selectively removed from the scooter.

According to a third aspect of the present invention, a scooter is provided. Particularly, the scooter includes a torque generator; at least one wheel which is coupled to the torque generator; a battery having a pair of oppositely charged terminals which are removably coupled to the torque generator; and a member which is attached to a certain portion of the scooter and which frictionally and removably receives the battery, thereby allowing the battery to be selectively removed from the scooter.

These and other features, aspects, and advantages of the present invention will become apparent from a reading of the following detailed description of the preferred embodiment of the invention in combination with the following drawings.

### BRIEF DESCRIPTION OF DRAWINGS

FIG. 1 is a perspective view of a scooter which is made in accordance with the teachings of the preferred embodiment of the invention.

FIG. 2 is a side view of the battery retention assembly which is shown in FIG. 1.

FIG. 3 is a side view of a battery retention assembly which is made in accordance with the teachings of an alternate embodiment of the invention.

FIG. 4 is a side view of a battery retention assembly which is made in accordance with the teachings of another alternate embodiment of the invention.

### DETAILED DESCRIPTION

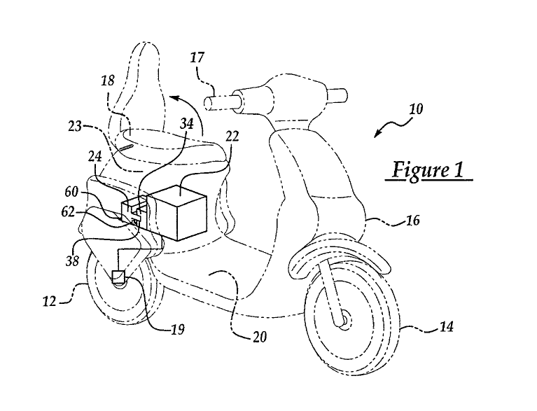

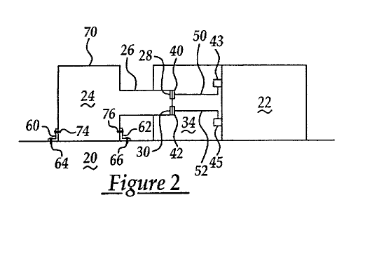

Referring now to FIGS. 1 and 2, there is shown a scooter assembly 10 which is made in accordance with the teachings of the preferred embodiment of the invention.

As shown, scooter assembly 10 includes a pair of wheels 12, 14 which are movably coupled to a frame assembly 16. Moreover, the frame assembly 16 includes a handlebar portion 17, an interior cavity 23, a seat portion 18 which is selectively moveable from a first position in which the seat 18 covers the generally hollow cavity 23 to a second remote position in which the seat 18 uncovers or allows access to the cavity 23. It should be realized that the scooter 10 is presented for illustration purposes only and that nothing in this description is meant to limit the applicability of the present invention to only the scooter 10 which is shown in FIG. 1. Further, it should be realized that the term scooter is meant to refer to an electrically powered assembly having less than four wheels and being adapted to transport one or more individuals, including but not limited to an electric bicycle.

Scooter 10 further includes a drive and/or gearing assembly 19 which is coupled to the wheel 12, a source of torque 22, such as an electric motor which may include a conventional power control assembly, and an electric battery 24. As shown, generally hollow cavity 23 houses the electric battery 24 and the torque generator 22. Particularly, the motor/torque generator 22 is coupled to drive and/or gearing assembly 19 and the assembly 19 is effective, upon receipt of electrical energy, to rotate the wheel 12 and propel the scooter 10. In one embodiment, the drive or gearing assembly 19 is eliminated and the wheel 12 is directly rotated by the motor/torque generator 22. Additionally, in the preferred embodiment of the invention, battery 24 includes a protruding portion 26 which includes oppositely charged terminals 28, 30, one of which may be coupled to electrical ground potential. In one non-limiting embodiment, portion 26 has a substantially rectangular cross sectional area, although other shapes and configurations may be utilized.

The scooter 10 also includes a terminal member 34 having a recessed portion 38 which frictionally engages the terminal protruding portion 26. Specifically, recessed portion 38 has a pair of electrically conductive surfaces 40, 42 which respectively contact the terminals 28, 30 when the protruding portion 26 is selectively placed within the recessed portion 38. Each surface 40, 42 is respectively coupled to an output terminal 43, 45 by a respective bus 50, 52. Each terminal 43, 45 is coupled to motor/torque generator 22, effective to allow electrical power to be communicated from the battery 24 to the motor 22 through terminals 28,30, terminals 40,42, buses 50,52 and terminals 43,45 (e.g., one electrical path is created through terminal 28, terminal 40, bus 50, and terminal 43 while a second electrical path is created through terminal 30, terminal 42, bus 52 and terminal 45). Torque generator 22 and terminal 34 may be fastened to surface 20 by conventional fasteners (e.g., screws (not shown)).

Further, a pair of substantially L shaped clamps 60, 62 may be removably attached to the support surface 20 (i.e., to the bottom surface of the cavity 23), by a respective fastener (e.g., by respective screws 64, 66) and may be removably attached to the battery casing 70 by respective fasteners (e.g., by respective screws 74, 76). In this manner, the battery 24 may be quickly removed from the support surface 20 and from cavity 23 without damaging the scooter 10 by removing fasteners/screws 74,76 and “pulling” portion 26 out of the recess 38. In one non-limiting embodiment, the length of portion 26 is substantially similar to the distance between members 60, 62. It should be appreciated that the extension portion 26 may be obviated and that a battery having a terminal configuration and a terminal surface which is substantially identical to that of a conventional automotive battery may be utilized. In this arrangement, the recessed portion 38 is widened, from that shown in FIGS. 1 and 2, and made much shallower. It should further be appreciated that members 60, 62 may be obviated and that terminal member 34 may singularly fix the battery 24 with the scooter 10. Moreover, terminal member 34 may be eliminated and, in this non-limiting embodiment, only the fasteners 60, 62 are used to removably fix the battery 24 upon surface 20 and the terminals 28, 30 of the battery 24 are directly coupled to the torque generator 22.

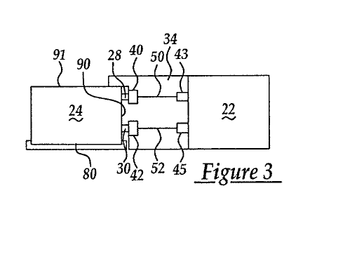

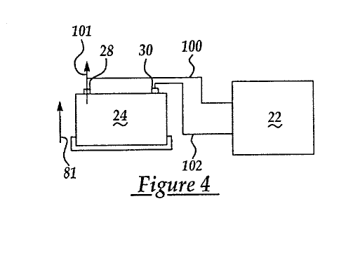

In an alternate embodiment of the invention, as shown best in FIG. 3, the clamps 60, 62 are replaced with a substantially “U”-shaped “boot type” member 80 which is attached to and/or which is integrally formed with the support portion 20 and which removably receives battery 24, thereby securing the battery 24 upon portion 20 while concomitantly allowing battery 24 to be easily removed from the scooter 10 by pulling the battery out of member 80. As shown, terminal surface 90 of the battery 24 may be substantially identical to that of a conventional automotive battery in the manner discussed above and, in this configuration, the respective longitudinal axis of symmetry 101 of the terminals 28, 30 is substantially parallel to the boot 80 and to surface 20. Further, in this embodiment, only a portion of the terminal member 34 overlays and frictionally engages the top surface 91 of the battery 24. As shown in FIG. 4, the battery 24 may also be placed within the boot 80 in an “upright” manner (e.g., the respective longitudinal axis of symmetry 101 of the terminals 28, 30 extend from the boot 80 along the direction 81 and are orthogonal to boot 80 and surface 20). These terminals 28, 30 may be physically connected to a desired terminal member or directly coupled to the motor or torque generator 22 by buses 100, 102.

It is to be understood that the invention is not limited to the exact construction which has been delineated above, but that various changes and modifications may be made without departing from the spirit and the scope of the invention as is more fully delineated within the following claims. For example, in yet another non-limiting embodiment, a locking assembly may be provided which allows a user to selectively lock or unlock the battery 24 in order to allow for relatively easy removal of the battery 24 while allowing the battery 24 to be secured within the scooter 10. That is, in this non-limiting embodiment, the screws 64, 66 are replaced with key operated fasteners (i.e., fasteners which are removable only by use of a key). In this embodiment, the ignition key may be used to remove these fasteners. Alternatively, a lock may be employed within terminal member 34 and is adapted to selectively prevent the portion 26 from being removed from recess 38. In yet another non-limiting embodiment, battery 24 is not housed in cavity 23 and may be secured within or upon another portion of scooter 10 using any of the methodologies disclosed above, while still providing electrical power to torque generator 22.

It should be appreciated that the easy removal of the battery 24 from the scooter 10 allows a “reserve” battery to be quickly and operatively inserted into the recess 38 to allow the scooter 10 to be used while the spent battery 24 is being “recharged” or “re-energized” and allows a user to remove the battery 24 when the scooter 10 is unattended, thereby reducing the likelihood of theft. Further, the battery 24 may be easily removed for service and easily removed and placed in a confined area in order to be “re-charged” or “re-energized”.

1. A scooter comprising a battery which is removable from said scooter without damaging said scooter.

2. The scooter of claim 1 further comprising a torque generator; at least one wheel which is coupled to said torque generator; and a member which is coupled to said generator and to said battery and which allows the battery to be removed from the scooter assembly without damaging the scooter assembly.

3. The scooter of claim 2, wherein said battery has a protruding portion and wherein said member has a recessed portion which selectively and removable receives said protruding portion of said battery.

4. The scooter of claim 3, wherein said recessed portion further includes a pair of conductors and wherein said battery further has a pair of oppositely charged terminals, each of said terminals contacting a unique one of said pair of conductors when said protruding portion is received by said recessed portion.

5. The scooter of claim 4, wherein said member further includes a second pair of conductors and wherein a first one of said pair of conductors is coupled to a first one of said second pair of conductors by a first bus and wherein a second one of said pair of conductors is coupled to a second one of said second pair of conductors by a second bus.

6. The scooter of claim 5, wherein each of said conductors of said second pair of conductors are further coupled to said torque generator, effective to selectively provide power to said torque generator when said protruding portion of said battery is operatively placed into said recessed portion.

7. The scooter of claim 2, wherein said scooter further comprises a gearing assembly which is coupled to said at least one wheel and to said torque generator.

8. The scooter of claim 3, wherein said protruding portion has a substantially rectangular cross sectional area.

9. The scooter of claim 2 further comprises a movable seat which selectively and removably covers said battery, said torque generator, and said member.

10. A scooter comprising a torque generator; at least one wheel which is coupled to said torque generator; a battery having a pair of oppositely charged terminals which is removably coupled to said torque generator; and at least one member which is removably attached to said battery and to said scooter and which allows said battery to be selectively removed from said scooter.

11. The scooter of claim 10, wherein said at least one member is generally L-shaped.

12. The scooter of claim 10, wherein said at least one member is attached to said battery by a first fastening member and wherein said at least one member is attached to a portion of said scooter by a second fastening member.

13. The scooter of claim 12 wherein said first fastening member comprises a key operated locking member and wherein said second fastening member comprises a screw.

14. The scooter of claim 10 further comprising a terminal member which receives said pair of oppositely charged terminals and which connects said pair of oppositely charged terminals to said torque generator.

15. A scooter comprising a torque generator; at least one wheel which is coupled to said torque generator; a battery having a pair of oppositely charged terminals which are removably coupled to said torque generator; and a member which is attached to a certain portion of said scooter and which frictionally and removably receives said battery, thereby allowing said battery to be selectively removed from said scooter.

16. The scooter of claim 15, wherein said member is further generally U-shaped.

17. The scooter of claim 15, wherein said battery has a pair of terminals having a respective longitudinal axis of symmetry which is perpendicular to said member.

18. The scooter assembly of claim 15, wherein said battery has a pair of terminals having a respective longitudinal axis of symmetry which is substantially parallel to said member.

19. The scooter of claim 16, further comprising a second member which couples said battery to said torque generator and which has a recessed portion which receives said pair of oppositely charged terminals.

20. The scooter of claim 19, further comprising a movable seat which selectively covers said battery.
